(19) United States
(12) Patent Application Publication
(10) Pub. No.: US 2024/0289384 A1
(43) Pub. Date: Aug. 29, 2024

(54) Local Node Embeddings for Heterogeneous Graphs

(71) Applicant: Google LLC, Mountain View, CA (US)

(72) Inventors: Kimon Fountoulakis, Kitchener (CA); Dake He, Toronto (CA)

(21) Appl. No.: 18/323,877

(22) Filed: May 25, 2023

(30) Foreign Application Priority Data
Feb. 22, 2023 (GR) 20230100153

(51) Int. Cl. G06F 16/901

(52) U.S. Cl. CPC G06F 16/9024; G06F 16/313

(57) ABSTRACT

Provided are computing systems, methods, and platforms that obtain local node embeddings for heterogeneous graphs. A heterogeneous graph comprising a plurality of nodes can be obtained. Weight values respectively associated with subgraphs of the heterogeneous graph can be determined. At least one node from among the plurality of nodes can be selected. An embedding for the at least one selected node can be learned using an embedding objective computed based on the weight values. The heterogeneous graph can be processed based on the embedding. Submodular hypergraphs can be used to represent heterogeneous graphs and their cuts. The [symbol] ₁-regularized personalized PageRank can be applied to hypergraphs, where the optimal solution gives the node embedding for the given seed nodes. The resulting [symbol] ₁-regularized personalized PageRank can be solved in running time without depending on the size of the whole graph.

### FIELD

The present disclosure relates generally to graphs. More particularly, the present disclosure relates to computing systems and methods for obtaining local node embeddings for expansive heterogeneous graphs.

### BACKGROUND

Relationships are exhibited across a wide range of scales within large graph data sets. However, some standard graph-based algorithms can be intrinsically biased towards coarse-scale global relationships among the nodes of a graph; therefore, the algorithms can struggle to identify the proverbial needles in this data haystack, as often small- and meso-scale relations among nodes are more meaningful in practice.

### SUMMARY

Aspects and advantages of embodiments of the present disclosure will be set forth in part in the following description, or can be learned from the description, or can be learned through practice of the embodiments.

One example aspect of the present disclosure is directed to a method for obtaining local node embeddings for heterogeneous graphs. The method includes obtaining, by a computing system comprising one or more processors, a heterogeneous graph comprising a plurality of nodes, wherein the heterogeneous graph comprises a plurality of subgraphs. The method further includes determining, by the computing system, a plurality of weight values respectively associated with the plurality of subgraphs. The method further includes selecting, by the computing system, at least one node from among a plurality of nodes. The method further includes learning, by the computing system and using an embedding objective computed based on the plurality of weight values, an embedding for the at least one node selected from among the plurality of nodes, wherein the embedding is based on a diffusion of an initial value distribution assigned to the at least one node selected from among the plurality of nodes. The method further includes processing, by the computing system, the heterogeneous graph based on the embedding.

Another example aspect of the present disclosure is directed to a computing system. The computing system includes one or more processors and one or more tangible, non-transitory computer-readable media that collectively store instructions that, when executed by the one or more processors, cause the one or more processors to perform operations. The operations include obtaining a heterogeneous graph comprising a plurality of nodes, wherein the heterogeneous graph comprises a plurality of subgraphs. The operations further include determining a plurality of weight values respectively associated with the plurality of subgraphs. The operations further include selecting at least one node from among the plurality of nodes. The operations further include learning, using an embedding objective computed based on the plurality of weight values, an embedding for the at least one node selected from among the plurality of nodes, wherein the embedding is based on a diffusion of an initial value distribution assigned to the at least one node selected from among the plurality of nodes. The operations further include processing the heterogeneous graph based on the embedding.

Another example aspect of the present disclosure is directed to one or more tangible, non-transitory computer-readable media that collectively store instructions that, when executed by one or more processors, cause the one or more processors to perform operations. The operations include obtaining a heterogeneous graph comprising a plurality of nodes, wherein the heterogeneous graph comprises a plurality of subgraphs. The operations further include determining a plurality of weight values respectively associated with the plurality of subgraphs. The operations further include selecting at least one node from among the plurality of nodes. The operations further include learning, using an embedding objective computed based on the plurality of weight values, an embedding for the at least one node selected from among the plurality of nodes, wherein the embedding is based on a diffusion of an initial value distribution assigned to the at least one node selected from among the plurality of nodes. The operations further include processing the heterogeneous graph based on the embedding.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of implementations directed to one of ordinary skill in the art is set forth in the specification, which makes reference to the appended figures, in which:

FIGS. 1A-1B depict graphical diagrams of an example network.

FIGS. 2A-2D depict graphical diagrams of higher-order relationships of a heterogeneous graph according to example embodiments of the present disclosure.

FIGS. 3A-3D depict diagrams of hyperedges based on the higher-order relationships of FIGS. 2A-2D according to example embodiments of the present disclosure.

FIGS. 4A-4B depict diagrams of hyperedge cuts and cut-costs according to example embodiments of the present disclosure.

FIGS. 5A-5B depict diagrams of hypergraphs according to example embodiments of the present disclosure.

FIG. 6 depicts a block diagram of an example computing system to obtain local node embeddings for heterogeneous graphs according to example embodiments of the present disclosure.

FIG. 7 depicts a flow chart diagram of an example method to obtain local node embeddings for heterogeneous graphs according to example embodiments of the present disclosure.

Reference numerals that are repeated across plural figures are intended to identify the same features in various implementations.

### DETAILED DESCRIPTION

### Overview

Generally, the present disclosure is directed to computing systems, methods, and platforms that obtain local node embeddings for heterogeneous graphs. Example computing systems, methods, and platforms can work directly on hypergraphs without any reduction to simpler graphs, thereby capturing any learned or user-defined semantics or patterns in a given heterogeneous graph. In addition, the example computing systems, methods, and platforms can work on submodular hypergraphs, as well as hypergraphs with unit or cardinality-based hyperedge cut-cost. For example, submodular cut-cost functions can be associated with a cut-cost function that can discriminate cuts of the same hyperedge, such as by assigning a different cost to each cut.

In particular, the systems and methods of the present disclosure can apply personalized PageRank, which is the most popular method for obtaining local node embeddings for standard graphs, to heterogeneous graphs and hypergraphs and, as a result, it can account for hyperedges of a hypergraph. First, submodular hypergraphs can be used to represent heterogeneous graphs and their cuts. Second, the [symbol] ₁-regularized personalized PageRank can be applied to hypergraphs, which is an optimization problem where the optimal solution gives the node embedding for the given seed node(s). Third, the resulting [symbol] ₁-regularized personalized PageRank can be solved efficiently in running time that does not depend on the size of the whole graph. Major advantages of personalized PageRank include that the embeddings for each node can be created in running time that does not depend on the size of the graph and, embarrassingly parallel, each node representation can be computed independently of the others.

In other implementations, the local node embeddings can be used to boost the performance of graph neural networks by providing the unsupervised local embeddings as features to the input of graph neural networks. The local node embeddings can also be used in any downstream task for semi-supervised, supervised, or unsupervised learning, node ranking, constructing similarity graphs, and clustering hypergraphs.

Existing methods can output global embeddings, which are dense and not localized around a given set of seed nodes, or local embeddings, where the output can be a sparse vector around a set of seed nodes. Local methods are the only ones that can be computed in a very scalable way for large hypergraphs. Many works propose global methods and thus are not always efficiently scalable to large hypergraphs. Some works are based on graph neural networks for heterogeneous graphs. Iterative hypergraph min-cut methods for the local hypergraph clustering problem can be adopted, where a sequence of hypergraph minimum cut problems can be solved to determine local node clusters. However, iterative hypergraph min-cut methods are not expansive, so they may not work with a single seed node as input and instead usually require a large enough input seed set of nodes. The size of the seed set depends on the amount of information required to be captured for a downstream task. Therefore, these methods require an additional level of tuning that is often difficult to control in practice. Given that the methods are not expansive, their embeddings capture only a limited amount of information from a local neighborhood of the given seed node(s). Combinatorial diffusion is generalized for hypergraphs and is expansive; however, combinatorial methods have a large bias towards low conductance neighborhoods as opposed to finding the target neighborhoods. Other existing methods depend on a reduction from hypergraphs to directed graphs, which results in an approximation error for clustering that is proportional to the size of hyperedges and induces performance degeneration when the hyperedges are large. Furthermore, current methods and local approaches are further limited to hypergraphs with unit-based or cardinality-based hyperedge cut-cost. Therefore, improvements that use local methods that are scalable to large hypergraphs and that work for submodular hypergraphs are desired.

Other existing methods for unsupervised clustering on heterogeneous graphs may be used to obtain node embeddings, however, they are not local, so their running time depends on the size of the whole graph, and they rely on a restrictive notion of colored- and typed-graphlet motifs which cannot model different cut-costs of the same motif.

One example technical advantage of the computing systems, methods, and platforms of the present disclosure is that submodular cut-cost functions can be handled. Submodular cut-cost functions can be associated with a cut-cost function that can discriminate cuts of the same hyperedge. For example, colored- and typed-graphlets treat all cuts for a hyperedge as identical and same cost, while the computing systems, methods, and platforms of the present disclosure can assign a different cost to each cut. Another technical advantage of the computing systems, methods, and platforms of the present disclosure is that they can work directly on hypergraphs without any reduction to simpler graphs, thereby capturing any learned or user-defined semantics or patterns in a given heterogeneous graph.

Technical effects of the example computing systems, methods, and platforms of the present disclosure are that the example computing systems, methods, and platforms can process heterogeneous graphs, work for submodular hypergraphs, be expansive, and work directly on hypergraphs without any reduction to simpler graphs, thereby capturing any user-defined semantics or patterns in a given heterogeneous graph. Moreover, the embeddings of the present disclosure can be used to boost the performance of graph neural networks by providing the unsupervised local embeddings as features to the input of graph neural networks.

First, submodular hypergraphs can be used to represent heterogeneous graphs and their cuts. Second, the [symbol] ₁-regularized personalized PageRank can be applied to hypergraphs, which is an optimization problem where the optimal solution gives the node embedding for the given seed node(s). Third, the resulting [symbol] ₁-regularized personalized PageRank can be solved efficiently in running time that does not depend on the size of the whole graph.

### Definitions and Notations for an Example Implementation

An example implementation is described in the following notation for the purposes of illustration only.

Submodular hypergraphs can be used to represent heterogeneous graphs and their cuts. In an example implementation, a heterogeneous graph with nodes associated with different classifications can be obtained. The heterogeneous graph can contain subgraphs, where each subgraph contains nodes from at least two of the different classifications. In some implementations, the heterogeneous graph may be a hypergraph and each subgraph can be a hyperedge of the hypergraph.

Given a set S. 2^{S} is denoted as the power set of S. |S| is denoted as the cardinality of S. and R is defined as the set of real numbers A submodular function F:2^{S}→ [symbol] is a set function such that F(A)+F(B)≥F(A∪B)+F(A∩B) for any A, B⊆S.

A heterogeneous graph can be a hypergraph. The hypergraph may have subgraphs, where a subgraph of the hypergraph can be considered a hyperedge of the hypergraph. Hypergraphs represent graphs by allowing a hyperedge to consist of multiple nodes that capture higher-order relations in the data. Hypergraphs have been used for music recommendation, news recommendation, sets of product reviews, and sets of co-purchased products. A hypergraph H=(V, E) can be defined by a set of nodes V and a set of hyperedges E⊆2^{V} (i.e., each hyperedge eϵE is a subset of V).

In the example where a submodular hypergraph represents a heterogeneous graph and the heterogeneous graph is a hypergraph, each subgraph or hyperedge of the hypergraph can be associated with a submodular function. For instance, a hypergraph may be termed submodular if every eϵE is associated with a submodular function wₑ:2^{e}→ [symbol] ₊, where [symbol] ₊ is the set of non-negative real numbers. Weight values associated with subgraphs or hyperedges can be determined. Additionally, each weight value can be a cut-cost of the subgraph or hyperedge respectively associated with the weight value. A cut-cost function can be used to determine the weight values. The cut-cost function can partition each subgraph or hyperedge into two subsets, which each include one or more nodes of the heterogeneous graph or hypergraph, and the cost of the partition can represent the cut-cost of the subgraph or hyperedge. For example, the weight value wₑ(S) indicates the cut-cost of splitting a subgraph or hyperedge e into two subsets, S and e\S. This form allows for describing the potentially complex higher-order relation among multiple nodes. A proper subgraph or hyperedge weight value wₑ should satisfy that wₑ(Ø)=wₑ(e)=0. To case notation, the domain of wₑ can be extended to 2^{V} by setting wₑ(S):=wₑ(S∩e) for any S⊆V.

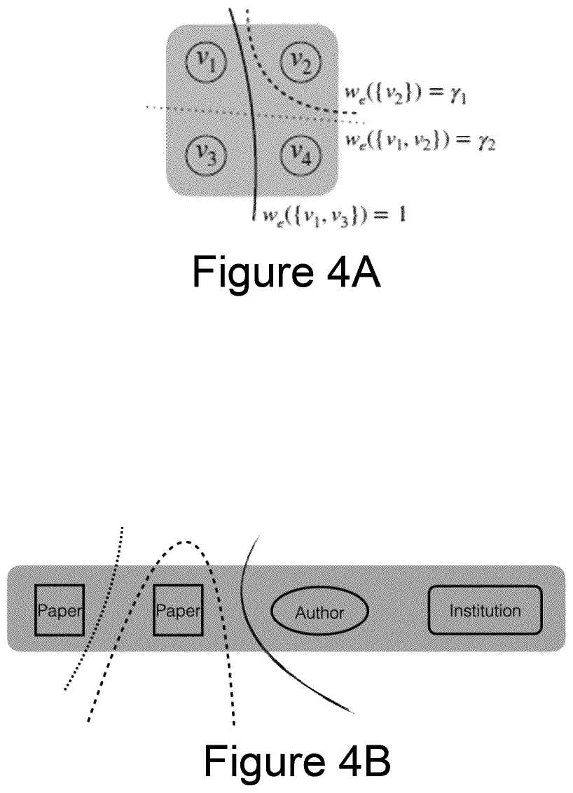

A submodular hypergraph can be written as H=(V, E, [symbol] ) where [symbol] :={wₑ, ϑₑ}_{eϵE} and ϑₑ>0 is a corresponding weight value of edge e. A cut-cost function can be a unit cut-cost function, a cardinality-based cut-cost function, or a submodular cut-cost function, as non-limiting examples. When wₑ(S)=1 for any Sϵ2^{e}\{Ø, e}, the definition reduces to unit cut-cost hypergraphs. In the simplest setting, where all cut-costs take value either 0 or 1 (e.g., the case when γ₁=γ₂=1 in FIG. 4A), a unit cut-cost hypergraph can be obtained. A cut-cost function can be a cardinality-based cut-cost function, resulting in a weight value that can represent the cardinality-based cut cost. When wₑ(S) only depends on |S|, it reduces to cardinality-based cut-cost hypergraphs. In a slightly more general setting, where the cut-costs may be determined solely by the number of nodes in either side of the subgraph or hyperedge cut (e.g., the case when γ₁=½ and γ₂=1 in FIG. 4A), a cardinality-based hypergraph can be obtained. A cut-cost function can be a submodular cut-cost function, resulting in a weight value that can represent the submodular cut-cost of the subgraph or hyperedge. Hypergraphs associated with arbitrary submodular cut-costs (e.g., the case for γ₁=½ and γ₂=0 in FIG. 4A) can be referred to as submodular hypergraphs. The sub-modular cut-cost can be associated with a cut-cost function that discriminates cuts of the same subgraph or hyperedge of the hypergraph.

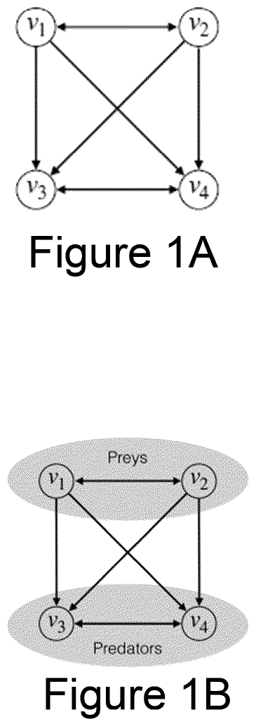

FIGS. 1A and 1B depict graphical diagrams of an example network. In FIGS. 1A and 1B, v₁, v₂, v₃, and v₄ represent the nodes of a food network. For example, the food network in FIGS. 1A and 1B can be mapped into a hypergraph by taking each network pattern as a hyperedge. This network pattern captures carbon flow from two preys (v₁, v₂) to two predators (v₃, v₄).

In the example of FIG. 4A, a hyperedge associated with cut-cost We models the relations of the food network of FIGS. 1A and 1B: wₑ is a set function defined over the node set e such that wₑ({vᵢ})=γ₁ for i=1, 2, 3, 4, wₑ({v₁, v₂})=γ₂, wₑ({v₁, v₃})=wₑ({v₁, v₄})=1 and wₑ(S)=wₑ(e\S) for S⊆e. The wₑ becomes the unit cut-cost when γ₁=γ₂=1. The wₑ may be cardinality-based if γ₁=½ and γ₂=1. More generally, We can be a submodular function for γ₁, γ₂ satisfying γ₂≤2γ₁≤γ₂+1 and γ₁≥½. The specific choices depend on the application.

For a set of nodes S⊆V, 1s may be denoted as the indicator vector of S (i.e., [1ₛ]ᵥ=1 if vϵS and 0 otherwise). Note that, for a vector xϵ [symbol] ^{|V|}, x(S):=Σ_{vϵS} xᵥ, where xᵥ in the entry in x that corresponds to vϵV. The support of x can be defined as supp(x):={vϵV|xᵥ≠0}. The support of a vector in [symbol] ^{|E|} can be defined analogously. Throughout the present disclosure, a function over nodes x:V→ [symbol] and its explicit representation as a |V|-dimensional vector are referred to interchangeably.

Given a submodular hypergraph H=(V, E, W), the degree of a node v can be defined as dᵥ:=Σ_{eϵE, vϵe} ϑₑ, and d can be reserved for the vector of node degrees and D=diag (d).

The base polytope for the submodular cut-cost We associated with a subgraph or hyperedge e can be defined as Bₑ:={ρₑϵ [symbol] ^{|V|}|ρₑ(S)≤wₑ(S), ∀S⊆V, and ρₑ(V)=wₑ(V)}. Consider rₑ=ϕₑρₑ for some ϕₑ≥0 and ρₑϵBₑ. It is straightforward to see that rₑ(v)=0 for every v∉e and rₑ^{T}1ₑ=0, so rₑ defines a proper flow routing over e. Moreover, for any e⊆V, recall that rₑ(S) represents the net amount of mass that moves from S to e\S over the subgraph or hyperedge e. Therefore, the constraints ρₑ(S)≤wₑ(S) for S⊆e mean that the directional flows rₑ(S) may be upper bounded by a submodular function ϕₑwₑ(S).

With reference now to the Figures, example implementations of the present disclosure will be discussed in greater detail.

### Example Heterogeneous Graphs as Hypergraphs

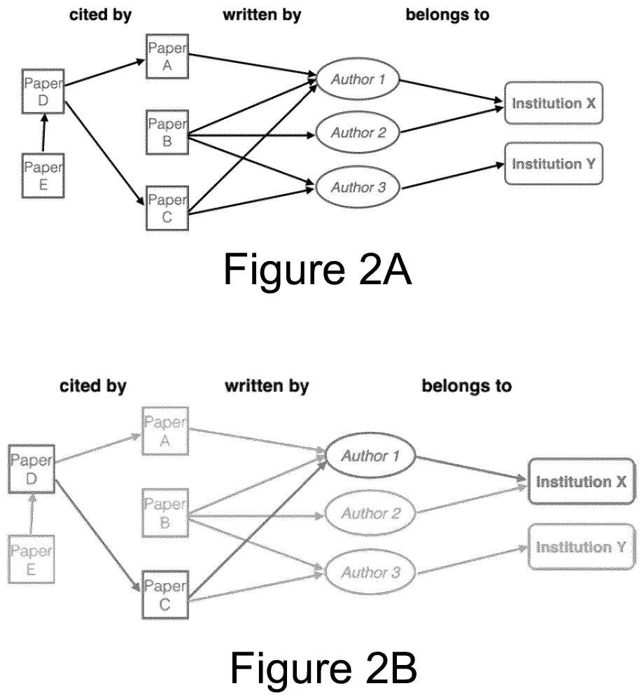

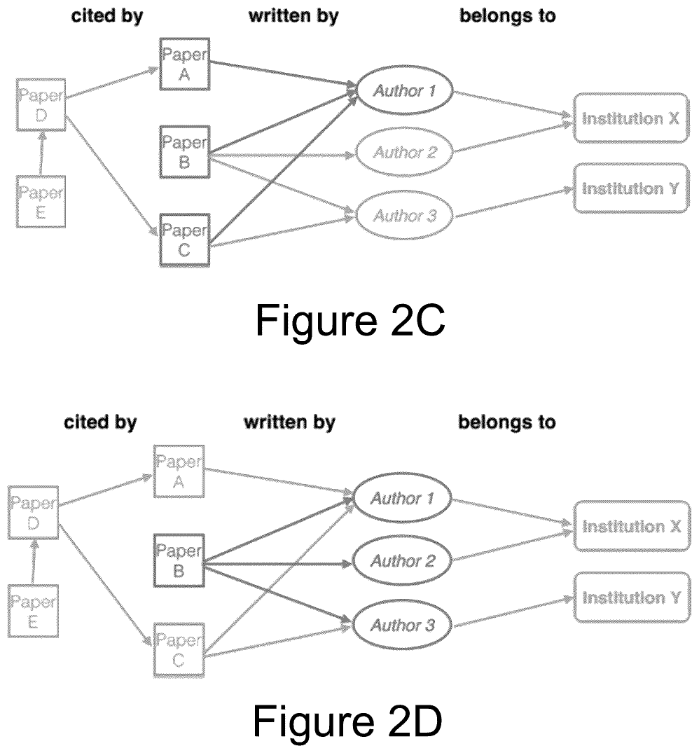

FIGS. 2A-2D depict graphical diagrams of higher-order relationships of a heterogeneous graph according to example embodiments of the present disclosure. In particular, FIG. 2A depicts a heterogeneous graph and FIGS. 2B-2D depict examples of higher-order relationships in the heterogeneous graph of FIG. 2A. A heterogeneous graph describes a graph whose nodes and edges can represent different types of entities and relations, respectively. For example, a heterogeneous graph can consist of different nodes and different types of edges can represent the relationship between those different nodes. In particular, FIG. 2A depicts a heterogeneous graph of a citation network.

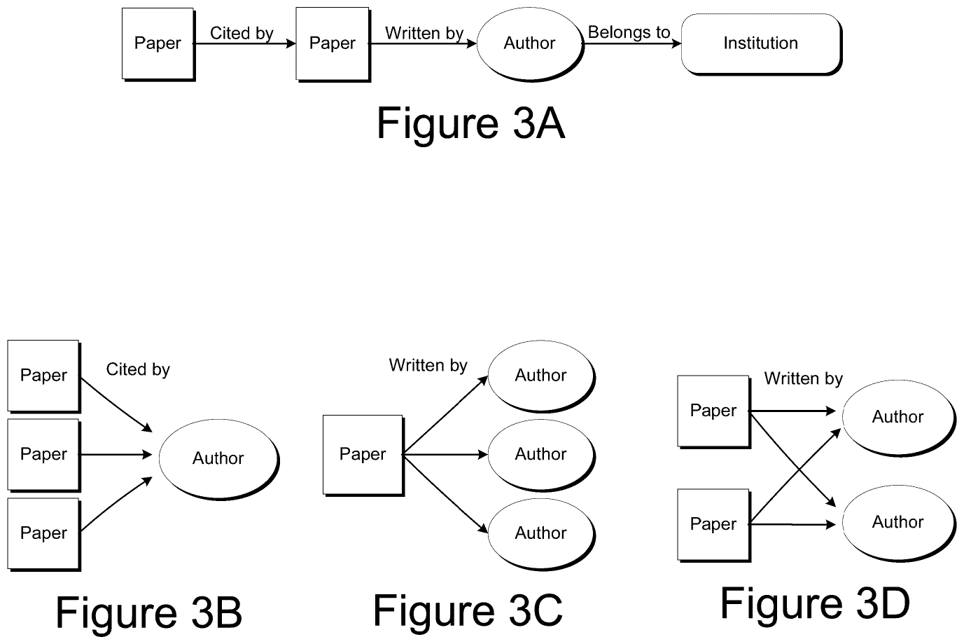

A heterogeneous graph can be obtained, and in some implementations the heterogeneous graph can be a hypergraph. Hypergraphs represent graphs by allowing a hyperedge to consist of multiple nodes that capture higher-order relations in the data, such as higher-order semantic relationships. For example, a higher-order relationship can be a connection between two nodes of a graph, a connection between one node of a graph and two or more other nodes of the graph, or a connection between two or more nodes of a graph and another node of the graph, as non-limiting examples. The subgraphs of a heterogeneous graph, or the hyperedges of a hypergraph, can describe such higher-order semantic relationships across the nodes of the heterogeneous graph or hypergraph. Downstream tasks on heterogeneous graphs often require exploiting higher-order relationships, which describe the relations between the nodes in the graph. For example, in the citation network in FIG. 2A, a higher-order relationship can be a paper that is cited by another paper written by an author who belongs to an institution, as depicted in FIG. 2B. In another example, in the citation network in FIG. 2A, a higher-order relationship can be a set of papers written by the same author, as depicted in FIG. 2C. In another example, in the citation network in FIG. 2A, a higher-order relationship can be a group of co-authors who wrote a paper together, as depicted in FIG. 2D. These higher-order relationships can be modeled as hyperedges (e.g., FIGS. 3A-3D).

FIGS. 3A-3D depict diagrams of hyperedges based on the higher-order relationships of FIGS. 2A-2D according to example embodiments of the present disclosure. In particular, FIG. 3A depicts a hyperedge based on the higher-order relationship depicted in FIG. 2B, FIG. 3B depicts a hyperedge based on the higher-order relationship depicted in FIG. 2C, FIG. 3C depicts a hyperedge based on the higher-order relationship depicted in FIG. 2D, and FIG. 3D depicts a hyperedge based on higher-order relationships depicted in FIG. 2A. A hyperedge may be a set of nodes that consist of types of nodes illustrated by the blocks in FIGS. 3A-3D. The connectivity patterns, based on which the hyperedges were created, are illustrated by the arrows between the blocks in FIGS. 3A-3D.

Higher-order relationships can be modeled as hyperedges of a hypergraph. For example, the hyperedge of the higher-order relationship in FIG. 2B may be any set of nodes that participate in the sequence shown in FIG. 3A. The hyperedge for the higher-order relationship in FIG. 2C may be any set of nodes that participate in the sequence shown in FIG. 3B. The hyperedge for the higher-order relationship in FIG. 2D may be any set of nodes that participate in the sequence shown in FIG. 3C.

FIGS. 4A-4B depict diagrams of hyperedge cuts and cut-costs according to example embodiments of the present disclosure. A hypergraph can be used to represent heterogeneous graphs with different cut-cost functions. PageRank can be formulated as a convex optimization problem, and involves defining how much it costs to separate nodes that comprise part of a hyperedge of a hypergraph. For example, there can be four distinct ways to cut a four-node hyperedge, so how to treat them should be determined, such as by finding the cost of each cut. Finding the cost of every cut of a hyperedge may ensure that the cuts to avoid are expensive. The cuts also allow for defining how the probability mask will be diffused, as during diffusion, it is desired to avoid sending a probability mask through predators.

The weight value wₑ(S) indicates the cut-cost of splitting the hyperedge e into two subsets, S and e\S. This allows for describing the potentially complex higher-order relation among multiple nodes. An example illustration of a hyperedge and its cut-cost is given in FIG. 4A. In the simplest setting, where all cut-costs take value either 0 or 1 (e.g., the case when γ₁=γ₂=1 in FIG. 4A), a unit cut-cost hypergraph can be obtained. In a slightly more general setting, where the cut-costs may be determined solely by the number of nodes in either side of the hyperedge cut (e.g., the case when γ₁=½ and γ₂=1 in FIG. 4A), a cardinality-based hypergraph can be obtained. Hypergraphs associated with arbitrary submodular cut-costs (e.g., the case for γ₁=½ and γ₂=0 in FIG. 4A) can be referred to as submodular hypergraphs. The sub-modular cut-cost can be associated with a cut-cost function that discriminates cuts of the same subgraph or hyperedge of the hypergraph.

In FIG. 4A, a hyperedge associated with cut-cost wₑ models the relations of the food network in FIGS. 1A-1B: We is a set function defined over the node set e such that wₑ({vᵢ})=γ₁ for i=1, 2, 3, 4, wₑ ({v₁, v₂})=γ₂, wₑ({v₁, v₃})=wₑ({v₁, v₄})=1 and wₑ(S)=wₑ(e\S) for S⊆e. The wₑ becomes the unit cut-cost when γ₁=γ₂=1. The wₑ may be cardinality-based if γ₁=½ and γ₂=1. More generally, wₑ can be a submodular function for γ₁, γ₂ satisfying γ₂≤2γ₁≤γ₂+1 and γ₁≥½.

Hypergraphs with submodular cut-cost functions can also model heterogeneous graphs with arbitrary edge cut-costs. As a result, a semantic meaning of original edges can be encoded via hyperedge cut-cost functions. For example, FIG. 4B depicts the different types of cuts for the hyperedge in FIG. 3A based on the higher-order relationship in FIG. 2B. In particular, FIG. 4B depicts the different ways that a hyperedge with the pattern paper cites paper written by an author who belongs to an institution can be cut. Hypergraphs can encode semantic meaning of original edges via hyperedge cut functions. Depending on what is more useful in a downstream task, submodular cut-costs can allow for picking the way that such a connectivity pattern should be cut and with what cost.

In another example, as depicted in FIG. 4A, in the example food network in FIGS. 1A-1B, when γ₂=0, separating the preys v₁, v₂ from the predators v₃, v₄ incurs 0 cost. As a result, the example systems and methods of the present disclosure may be encouraged to rank similar species similarly because the systems and methods assign similar species with similar output weight values.

### Example Implementation of Personalized PageRank for Hypergraphs

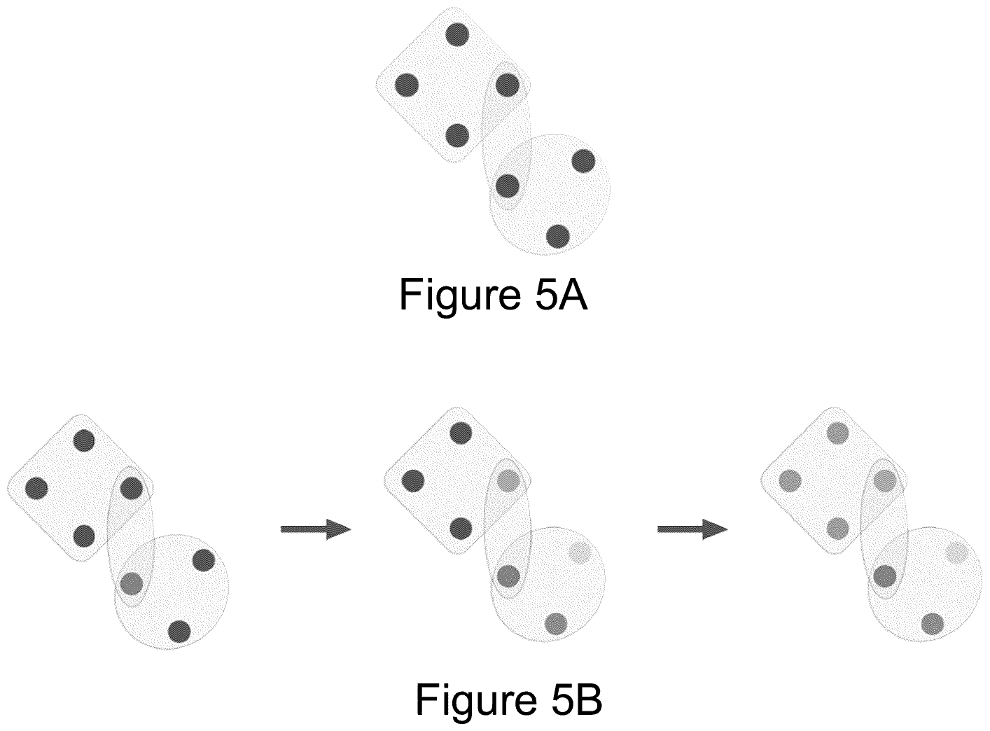

FIGS. 5A-5B depict diagrams of hypergraphs according to example embodiments of the present disclosure. In particular, FIG. 5A depicts a hypergraph and FIG. 5B depicts a diagram of PageRank on hypergraphs according to example embodiments of the present disclosure. At least one node can be selected and, using an embedding objective computed based on the weight values, such as iteratively computing a proxy objective, local node embeddings for the at least one selected node can be learned. The embedding can be based on a diffusion of an initial value distribution assigned to the at least one selected node. In some implementations, the local node embeddings can comprise scores for the plurality of nodes (i.e., weight values of edges between the local nodes and the plurality of nodes) of the heterogeneous graph or hypergraph, which can be learned.

In some implementations, a submodular hypergraph can be obtained. For example, the [symbol] ₁-regularized PageRank optimization problem, which is a variational version of the popular push-flow PageRank method, can be applied to submodular hypergraphs. The proposed optimization problem takes as input a seed node or a set of seed nodes. The solution to the optimization problem can be the embedding of the given seed node.

Given a set of seed nodes, each seed node may be assigned some initial probability mass, specified by a source function Δ (i.e., seed node v holds Δ(v) amount of mass and 1^{T}Δ=1). As a result, the following implementation of [symbol] ₁-regularized PageRank to the hypergraph setting may be obtained:

$${min}_{p ∈ {ℝ}_{+}^{\vert V \vert}} ρα {d}^{T} p - {αΔ}^{T} p + \frac{α}{2} {‖ p ‖}_{D}^{2} + \frac{1 - α}{4} {\sum }_{e ∈ E} {ϑ}_{e} {{f}_{e} ( p )}^{2} , \qquad ( 1 )$$

where fₑ is the support function of the polytope Bₑ given by fₑ(p): =max_{ρ}_{ₑ}_{ϵB}_{ₑ}ρₑ^{T}p, and ∥p∥_{D}:=\sqrt{p^{T}Dp} is the scaled Euclidean norm. This is referred to herein as the hypergraph PageRank problem (1). One parameter, α, models the probability of teleporting from any node to the seed node. The input is the source function Δ, the hypergraph H=(V, E, W), and the PageRank teleportation parameter αϵ[0,1].

The solution p to this dual optimization problem (i.e., the hypergraph PageRank problem (1)) can be a vector of length equal to the number of nodes that embeds nodes into the nonnegative real line. This is the node embedding for the corresponding input seed node(s).

A diagonal matrix Θϵ [symbol] ^{|E|×|E|} can be defined such that [Θ]_{e,e}=ϑₑ. The dual problem of the hypergraph PageRank problem (1) is:

$${min}_{ϕ ∈ {ℝ}_{+}^{\vert E \vert} , p ∈ {ℝ}_{+}^{\vert V \vert}} \frac{1 - α}{4} {‖ ϕ ‖}_{Θ}^{2} + \frac{α}{2} {‖ p ‖}_{D}^{2} \\ subject to αΔ - \frac{1 - α}{2} {\sum }_{e ∈ E} {ϑ}_{e} {r}_{e} \leq ρα d + α Dp \\ {r}_{e} ∈ {ϕ}_{e} {B}_{e} , ∀ e ∈ E , \qquad ( 2 )$$

This is referred to herein as the dual problem (2).

### Example Optimization Algorithm

Solving the hypergraph PageRank problem obtains the local node embedding, which can be used in various applications. The hypergraph PageRank node embedding can be computed using the dual problem of the hypergraph PageRank problem. The present disclosure proposes an Alternating Minimization method that efficiently solves the dual problem (2) of the hypergraph PageRank problem (1).

For each subgraph or hyperedge eϵE, a diagonal matrix Aₑϵ [symbol] ^{|V|×|V|} can be defined such that [Aₑ]_{v,v}=1 if vϵe and 0 otherwise. The following lemma casts the dual problem (2) to an equivalent separable formulation amenable to the Alternating Minimization method.

Lemma 1: The following problem is equivalent to the dual problem (2) for any αϵ[0,1], in the sense that (\hat{ϕ}, \hat{r}, \hat{p}) is optimal in the dual problem (2) for some \hat{p}ϵ [symbol] ^{|V|} if and only if (\hat{ϕ}, \hat{r}, ŝ) is optimal in the following problem for some ŝϵ⊗_{eϵE} [symbol] ^{|V|}.

$${min}_{ϕ , r , s} \frac{1 - α}{4} {\sum }_{e ∈ E} {ϑ}_{e} ( {ϕ}_{e}^{2} + \frac{1 - α}{2 α} {‖ {s}_{e} - {r}_{e} ‖}_{2}^{2} ) \\ s . t . {r}_{e} ∈ {ϕ}_{e} {B}_{e} ∀ e ∈ E , αΔ - \frac{1 - α}{2} {\sum }_{e ∈ E} {ϑ}_{e} {s}_{e} \leq ρα d , {s}_{e , v} = 0 , ∀ v ∉ e . \qquad ( 3 )$$

This is referred to herein as the equivalent dual problem (3).

Proof: Both the forward direction and the converse follow from exactly the same reasoning. Let \hat{v}₁ and \hat{v}₂ denote the optimal objective value of the dual problem (2) and the equivalent dual problem (3), respectively. Let (\hat{ϕ},\hat{r}, \hat{p}) be an optimal solution for the dual problem (2). Define

$${\hat{s}}_{e} := {\hat{r}}_{e} + \frac{2 α}{1 - α} {A}_{e} \hat{p}$$

for eϵE. It can be shown that (\hat{ϕ}, \hat{r},ŝ) is an optimal solution for the equivalent dual problem (3).

Because \hat{r}_{e,v}=0 for all v∉e, by the definition of Aₑ, it is known that ŝ_{e,v}=0 for all v∉e. Moreover,

$$α D \hat{p} = α {\sum }_{e ∈ E} {ϑ}_{e} {A}_{e} \hat{p} = \frac{1 - α}{2} {\sum }_{e ∈ E} {ϑ}_{e} ( {\hat{s}}_{e} - {\hat{r}}_{e} ) , so \\ αΔ - \frac{1 - α}{2} {\sum }_{e ∈ E} {ϑ}_{e} {\hat{s}}_{e} = αΔ - \frac{1 - α}{2} {\sum }_{e ∈ E} {ϑ}_{e} {\hat{r}}_{e} - α D \hat{p} \leq ρα d .$$

Therefore, (\hat{ϕ}, \hat{r}, ŝ) is a feasible solution for the equivalent dual problem (3). Furthermore,

$$\begin{matrix}\frac{α}{2} {\sum }_{v ∈ V} {d}_{v} {\hat{p}}_{v}^{2} = \frac{α}{2} {\sum }_{e ∈ E} {ϑ}_{e} {\sum }_{v ∈ e} {\hat{p}}_{v}^{2} = \frac{α}{2} {\sum }_{e ∈ E} {ϑ}_{e} {‖ {A}_{e} \hat{p} ‖}_{2}^{2} \\ = \frac{{( 1 - α )}^{2}}{8 α} {\sum }_{e ∈ E} {ϑ}_{e} {‖ {\hat{r}}_{e} - {\hat{s}}_{e} ‖}_{2}^{2}\end{matrix} .$$

This means that (\hat{ϕ}, \hat{r}, ŝ) attains objective value \hat{v}₁ in the equivalent dual problem (3). Hence \hat{v}₁≥\hat{v}₂.

In order to show that (\hat{ϕ}, \hat{r}, ŝ) is indeed optimal for the equivalent dual problem (3), it is left to show that \hat{v}₂≥\hat{v}₁.

Let (ϕ′, r′, s′) be an optimal solution for the equivalent dual problem (3). Then,

$${s}^{′} = arg {min}_{s ∈ \begin{matrix}⊗ \\ e ∈ E\end{matrix} {ℝ}^{\vert V \vert}} {\sum }_{e ∈ E} {ϑ}_{e} {‖ {s}_{e} - {r}_{e}^{′} ‖}_{2}^{2} , \\ s . t . αΔ - \frac{1 - α}{2} {\sum }_{e ∈ E} {ϑ}_{e} {s}_{e} \leq ρ α d , {s}_{e , v} = 0 ∀ v ∉ e .$$

According to Lemma 2, it is known that

$${s}_{e}^{′} = {r}_{e}^{′} + {A}_{e} {{D}^{- 1} [ αΔ - \frac{1 - α}{2} {\sum }_{e ′ ∈ E} {ϑ}_{e ′} {r}_{e ′}^{′} - ρα d ]}_{+} , ∀ e ∈ E .$$

### Define

$${p}^{′} := \frac{1 - α}{2 α} {{D}^{- 1} [ αΔ - \frac{1 - α}{2} {\sum }_{e ∈ E} {ϑ}_{e} {r}_{e}^{′} - ρα d ]}_{+}$$

Then z′≥0. Moreover, it is that

$$\begin{matrix}\frac{1 - α}{2} {\sum }_{e ∈ E} {ϑ}_{e} {s}_{e}^{′} - {\sum }_{e ∈ E} {ϑ}_{e} {r}_{e}^{′} = \frac{1 - α}{2} {\sum }_{e ∈ E} {ϑ}_{e} {A}_{e} {D}^{- 1} [ αΔ - \\ {\frac{1 - α}{2} {\sum }_{e ′ ∈ E} {ϑ}_{e ′} {r}_{e ′}^{′} - ρα d ]}_{+} \\ = {\frac{1 - α}{2} [ αΔ - \frac{1 - α}{2} {\sum }_{e ′ ∈ E} {ϑ}_{e ′} {r}_{e ′}^{′} - ρα d ]}_{+} \\ = α {Dp}^{′}\end{matrix} , \\ so \\ αΔ - \frac{1 - α}{2} {\sum }_{e ∈ E} {ϑ}_{e} {r}_{e}^{′} = αΔ - \frac{1 - α}{2} {\sum }_{e ∈ E} {ϑ}_{e} {s}_{e}^{′} + α {Dp}^{′} \leq ρα d + α {Dp}^{′} .$$

Therefore, (ϕ′, r′, p′) is a feasible solution for the dual problem (2). Furthermore,

$$\frac{{( 1 - α )}^{2}}{8 α} {\sum }_{e ∈ E} {ϑ}_{e} {‖ {s}_{e}^{′} - {r}_{e}^{′} ‖}_{2}^{2} = \frac{α}{2} {\sum }_{e ∈ E} {ϑ}_{e} {‖ {A}_{e} {p}^{′} ‖}_{2}^{2} = \frac{α}{2} {\sum }_{e ∈ E} {ϑ}_{e} {\sum }_{v ∈ e} {p}_{v}^{′ 2} = \frac{α}{2} {\sum }_{v ∈ V} {d}_{v} {p}_{v}^{′ 2} .$$

This means that (ϕ′, r′, p′) attains objective value \hat{v}₂ in the dual problem (2). Hence \hat{v}₂≥\hat{v}₁.

Alternating Minimization Algorithm for the Equivalent Dual Problem (3): The following algorithm gives the algorithm applied to the equivalent dual problem (3).

### Initialization:

$${ϕ}^{( 0 )} := 0 , {r}^{( 0 )} := 0 , {s}_{e}^{( 0 )} := {D}^{- 1} {{A}_{e} [ Δ - ρα d ]}_{+} , ∀ e ∈ E .$$

For k=0,1,2, . . . do:

$$( {ϕ}^{( k + 1 )} , {r}^{( k + 1 )} ) := arg {min}_{{r}_{e} ∈ {ϕ}_{e} {B}_{e} ∀ e ∈ E} {\sum }_{e ∈ E} {ϑ}_{e} ( {ϕ}_{e}^{2} + \frac{1 - α}{2 α} {‖ {s}_{e}^{( k )} - {r}_{e} ‖}_{2}^{2} ) \\ {s}^{( k + 1 )} := arg {min}_{s} {\sum }_{e ∈ E} {ϑ}_{e} {‖ {s}_{e} - {r}_{e}^{( k + 1 )} ‖}_{2}^{2} \\ s . t . αΔ - \frac{1 - α}{2} {\sum }_{e ∈ E} {ϑ}_{e} {s}_{e} \leq ρα d , {s}_{e , v} = 0 , ∀ v ∉ e .$$

The first sub-problem corresponds to computing projections to a group of cones, where all the projections can be computed in parallel. The computation of each projection depends on the choice of base polytope Bₑ. If the subgraph or hyperedge weight wₑ is unit cut-cost, Bₑ holds special structures and projection can be computed with O(|e|log|e|). For general Bₑ, a conic Fujishige-Wolfe minimum norm algorithm can be adopted to obtain the projection. The second sub-problem in the Alternating Minimization Algorithm for the Equivalent Dual Problem (3) can be easily computed in closed-form. The optimal solution for the second sub-problem is given by the following lemma, Lemma 2.

Lemma 2: The optimal solution to the sub-problem,

$${{min}_{s ∈ ⊗ {ℝ}^{\vert V \vert}}}_{e ∈ E} {\sum }_{e ∈ E} {ϑ}_{e} {‖ {s}_{e} - {r}_{e} ‖}_{2}^{2} , s . t . α Δ - \frac{1 - α}{2} {\sum }_{e ∈ E} {ϑ}_{e} {s}_{e} \leq ρ α d , {s}_{e , v} = 0 , ∀ v ∉ e ,$$

is given by

$${s}_{e}^{*} = {r}_{e} + {A}_{e} {{D}^{- 1} [ α Δ - \frac{1 - α}{2} {\sum }_{e ′ ∈ E} {ϑ}_{{e}^{′}} {r}_{{e}^{′}} - ρα d ]}_{+} , ∀ e ∈ E .$$

This is referred to herein as the optimal solution to the sub-problem.

Proof: Rewrite the sub-problem as

$${{min}_{s ∈ ⊗ {ℝ}^{\vert V \vert}}}_{e ∈ E} {\sum }_{v ∈ V} {\sum }_{e ∈ E} {ϑ}_{e} {\vert {s}_{e , v} - {r}_{e , v} \vert}^{p}$$

$$s . t . α {Δ}_{v} - \frac{1 - α}{2} {\sum }_{e ∈ E} {ϑ}_{e} {s}_{e , v} \leq ρα {d}_{v} , ∀ v ∈ V$$

$${s}_{e , v} = 0 , ∀ v ∉ e .$$

Then it is immediate to see that the sub-problem decomposes into |V| sub-problems indexed by vϵV,

$${min}_{{ξ}_{v} ∈ {ℝ}^{\vert {E}_{v} \vert}} {\sum }_{e ∈ {E}_{v}} {ϑ}_{e} {\vert {ξ}_{v , e} - {r}_{e , v} \vert}^{p} , s . t . {αΔ}_{v} - \frac{1 - α}{2} {\sum }_{e ∈ {E}_{v}} {ϑ}_{e} {ξ}_{v , e} \leq ρ α {d}_{v} ,$$

where Eᵥ:={eϵE|vϵe} is the set of hyperedges incident to v, and ξ_{v,e} is used for the entry in ξᵥ that corresponds to eϵEᵥ.

Let ξᵥ* denote the optimal solution for

$${min}_{{ξ}_{v} ∈ {ℝ}^{\vert {E}_{v} \vert}} {\sum }_{e ∈ {E}_{v}} {ϑ}_{e} {\vert {ξ}_{v , e} - {r}_{e , v} \vert}^{p} , s . t . {αΔ}_{v} - \frac{1 - α}{2} {\sum }_{e ∈ {E}_{v}} {ϑ}_{e} {ξ}_{v , e} \leq ρ α {d}_{v} .$$

Then s_{e,v}*=ξ_{v,e}* if vϵe and s_{e,v}*=0 otherwise. Therefore, it suffices to find ξᵥ* for vϵV. The optimality condition of

$${min}_{{ξ}_{v} ∈ {ℝ}^{\vert {E}_{v} \vert}} {\sum }_{e ∈ {E}_{v}} {ϑ}_{e} {\vert {ξ}_{v , e} - {r}_{e , v} \vert}^{p} , s . t . {αΔ}_{v} - \frac{1 - α}{2} {\sum }_{e ∈ {E}_{v}} {ϑ}_{e} {ξ}_{v , e} \leq ρ α {d}_{v}$$

is given by

$$2 {ϑ}_{e} ( {ξ}_{v , e} - {r}_{e , v} ) - {ϑ}_{e} λ = 0 , ∀ e ∈ {E}_{v} ,$$

$$λ \geq 0 , α {Δ}_{v} - \frac{1 - α}{2} {\sum }_{e ∈ {E}_{v}} {ϑ}_{e} {ξ}_{v , e} \leq ρ α {d}_{v} , λ ( α {Δ}_{v} - \frac{1 - α}{2} {\sum }_{e ∈ {E}_{v}} {ϑ}_{e} {ξ}_{v , e} - ρ α {d}_{v} ) = 0 .$$

There are two cases about λ. It can be shown that in both cases, the solution given by

$${s}_{e}^{*} = {r}_{e} + {A}_{e} {{D}^{- 1} [ α Δ - \frac{1 - α}{2} {\sum }_{e ′ ∈ E} {ϑ}_{e ′} {r}_{e ′} - ρα d ]}_{+} , ∀ e ∈ E$$

(i.e., the optimal solution to the sub-problem) is optimal.

Case 1: If λ>0, then it must be that 2ϑₑ(ξ_{v,e}−r_{e,v})>0 for all eϵEᵥ, otherwise the stationarity condition would be violated. This means that 2(ξ_{v,e}−r_{e,v})=λ for all eϵEᵥ, that is, ξ_{v,e}_{₁}−rₑ_{₁}_{,v}=ξ_{v,e}_{₂}−rₑ_{₂}_{,v}>0 for every e₁, e₂ϵEᵥ. Denote tᵥ:=ξ_{v,e}−r_{e,v}. Because λ>0, by complementarity

$$α {Δ}_{v} - \frac{1 - α}{2} {\sum }_{e ∈ {E}_{v}} {ϑ}_{e} ( {t}_{v} + {r}_{e , v} ) = α {Δ}_{v} - \frac{1 - α}{2} {\sum }_{e ∈ {E}_{v}} {ϑ}_{e} {ξ}_{v , e} = ρ α {d}_{v} ,$$

which implies that

$${t}_{v} = {( {\sum }_{e ∈ {E}_{v}} {ϑ}_{e} )}^{- 1} ( α {Δ}_{v} - \frac{1 - α}{2} {\sum }_{e ∈ {E}_{v}} {ϑ}_{e} {r}_{e , v} - ρ α {d}_{v} ) .$$

Note that

$$α {Δ}_{v} - \frac{1 - α}{2} {\sum }_{e ∈ {E}_{v}} {ϑ}_{e} {r}_{e , v} - ρ α {d}_{v} > 0$$

because

$$α {Δ}_{v} - \frac{1 - α}{2} {\sum }_{e ∈ {E}_{v}} {ϑ}_{e} {ξ}_{v , e} - ρ α {d}_{v} = 0 and {ξ}_{v , e} > {r}_{e , v}$$

for all eϵEᵥ. Therefore,

$${s}_{e , v}^{*} = {ξ}_{v , e}^{*} = {r}_{e , v} + {{d}_{v}^{- 1} [ α {Δ}_{v} - \frac{1 - α}{2} {\sum }_{e ∈ {E}_{v}} {ϑ}_{e} {r}_{e , v} - ρ α {d}_{v} ]}_{+} .$$

Case 2: If λ=0, then 2ϑₑ(ξ_{v,e}−r_{e,v})=0 for all eϵEᵥ, which implies ξ_{v,e}−r_{e,v}=0 for all eϵEᵥ. Then it must be that

$$α {Δ}_{v} - \frac{1 - α}{2} {\sum }_{e ∈ {E}_{v}} {ϑ}_{e} {r}_{e , v} = α {Δ}_{v} - \frac{1 - α}{2} {\sum }_{e ∈ {E}_{v}} {ϑ}_{e} {ξ}_{v , e} \leq ρ α {d}_{v} .$$

Therefore, it is still that

$${s}_{e , v}^{*} = {ξ}_{v , e}^{*} = {r}_{e , v} = {r}_{e , v} + {{d}_{v}^{- 1} [ α {Δ}_{v} - \frac{1 - α}{2} {\sum }_{e ∈ {E}_{v}} {ϑ}_{e} {r}_{e , v} - ρ α {d}_{v} ]}_{+} .$$

The required result then follows from the definition of Aₑ and D.

It is noted that the computation of each step of the proposed algorithm is local. This means that each step can be computed in running time that depends on the size of the support of non-zero nodes at iteration k in vector p and their number of neighbors. Additionally, since the method is expansive, at each iteration the support of the non-zero nodes can only increase by the size of their neighbors. The support of current non-zero nodes can also decrease, but a node cannot suddenly become non-zero without having a path of non-zero nodes that lead to that node.

### Example Applications

The solution to the dual optimization problem (i.e., the hypergraph PageRank problem (1)) may be a vector of length equal to the number of nodes that embeds nodes into the nonnegative real line. A heterogeneous graph can then be processed based on the local node embedding, including ranking the nodes, constructing a similarity heterogeneous graph, and sorting the local nodes and performing a sweep-cut method to obtain a smaller local cluster of nodes, as non-limiting examples.

For example, one can obtain an embedding for all or part of the nodes in the graph by solving the dual optimization problem (i.e., the hypergraph PageRank problem (1)) for the nodes of interest. The node embeddings can then be used in any downstream task for semi-supervised, supervised, or unsupervised learning.

Another application of the present disclosure can be node ranking. For the hypergraph PageRank problem (1), one can view the solution p as assigning heights to nodes, and the goal is to separate the nodes with source mass from the rest of the heterogeneous graph or hypergraph. Observe that the linear term in the objective function encourages raising p higher on the seed nodes and setting it lower on others. The cost fₑ(p) captures the discrepancy in node heights over a subgraph or hyperedge e and encourages smooth height transition over adjacent nodes.

Since the solution of the hypergraph PageRank problem (1) may be non-negative, the solution can also be represented as a set of edges between the seed node(s) and the rest of the graph. For example, if the hypergraph PageRank problem (1) has been solved for seed node u, then the i-th coordinate of the vector pᵢ gives us the weight of the edge between nodes u and i. Therefore, if we solve the hypergraph PageRank problem (1) for all or part of the nodes in the graph as seed nodes, then this provides a similarity sub-graph. Effects of different tuning parameters for each seed node can be normalized by normalizing the embedding for each node to be unit-norm.

Another application of the present disclosure can be local hypergraph clustering. One can sort the nodes in p and perform a sweep-cut method to threshold the ordered vector p and obtain a small set of nodes that consist of a local cluster.

By providing node embeddings and node rankings, constructing similarity graphs, and clustering hypergraphs, the solutions in the present disclosure can be used in real-world applications, such as finding similar entities in a social network, identifying similar webpages or domains for search or archiving, locating similar audiences for ad targeting, and detecting anomalies in connected sites. The local node embeddings of the present disclosure can also be applied to various computing platforms and can provide graph-learning tools for applications, such as fraud detection and computer security analysis, and can improve customer experiences on such computing platforms.

Other example implementations of the present disclosure may include applications in chemistry or biology, such as in microarray experiments that measure gene expression or finding correlated genes, applications in neuroscience to understand changes in brain structure, logic programming, and improving database querying.

### Example Devices and Systems

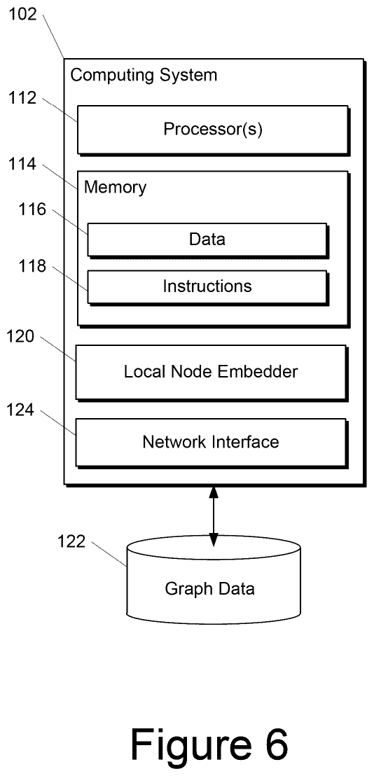

FIG. 6 depicts an example computing system 102 that can implement the present disclosure. The computing system 102 can include one or more physical computing devices. The one or more physical computing devices can be any type of computing device, including a server computing device, a personal computer (e.g., desktop or laptop), a mobile computing device (e.g., smartphone or tablet), an embedded computing device, or other forms of computing devices, or combinations thereof. The computing device(s) can operate sequentially or in parallel. In some implementations, the computing device(s) can implement various distributed computing techniques.

The computing system includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor(s) 112 to cause the computing system 102 to perform operations.

The computing system 102 can further include a local node embedder 120 that is implementable to obtain local node embeddings for heterogeneous graphs. In particular, the computing system 102 can implement the local node embedder 120 to obtain local node embeddings of a graph that is represented by graph data 122 that is stored in a database. For example, the local node embedder 120 can perform any of the example methods, techniques, or frameworks discussed herein on the graph data 122 to obtain local node embeddings for heterogeneous graphs.

The local node embedder 120 can include computer logic utilized to provide desired functionality. The local node embedder 120 can be implemented in hardware, firmware, and/or software controlling a general purpose processor. For example, in some implementations, the local node embedder 120 includes program files stored on a storage device, loaded into a memory and executed by one or more processors. In other implementations, the local node embedder 120 includes one or more sets of computer-executable instructions that are stored in a tangible computer-readable storage medium such as RAM hard disk or optical or magnetic media.

The computing system 102 can also include a network interface 124 used to communicate with one or more systems or devices, including systems or devices that are remotely located from the computing system 102. The network interface 124 can include any number of components to provide networked communications (e.g., transceivers, antennas, controllers, cards, etc.).

### Example Methods

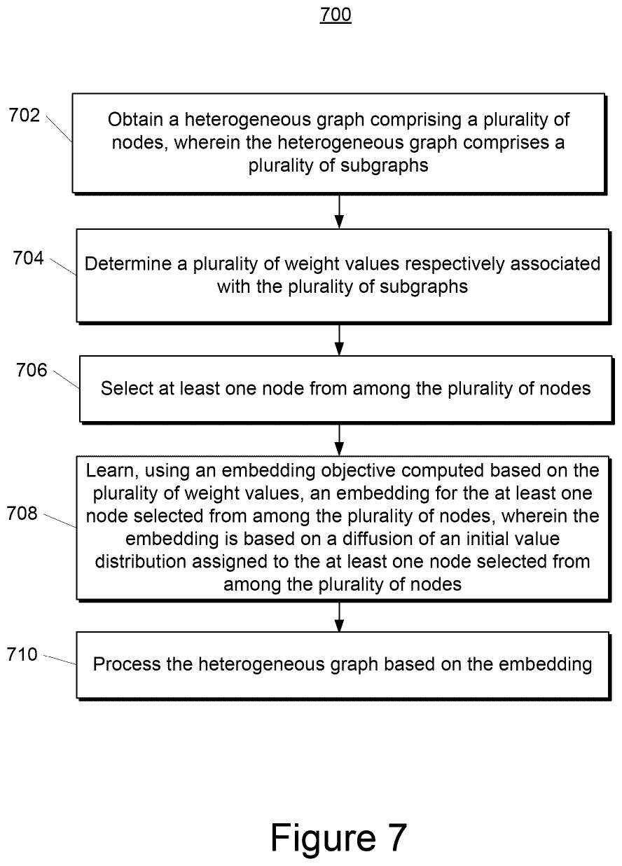

FIG. 7 depicts a flow chart diagram of an example method 700 to obtain local node embeddings for heterogeneous graphs according to example embodiments of the present disclosure.

At 702, a computing system obtains a heterogeneous graph comprising a plurality of nodes, wherein the heterogeneous graph comprises a plurality of subgraphs. For example, a hypergraph can be created based on the heterogeneous graph and each subgraph can be a hyperedge of the hypergraph. In addition, the subgraphs can describe higher-order semantic relationships across the nodes of the heterogeneous graph or the hypergraph. Example higher-order semantic relationships can include a connection between a first node of the heterogeneous graph or hypergraph and a second node of the heterogeneous graph or hypergraph, a connection between a first node of the heterogeneous graph or hypergraph and two or more nodes of the heterogeneous graph or hypergraph, and a connection between two or more nodes of the heterogeneous graph or hypergraph and another node of the heterogeneous graph or hypergraph. In some implementations, the hypergraph can be a submodular hypergraph and each hyperedge of the submodular hypergraph can be associated with a submodular function.

At 704, the computing system determines a plurality of weight values respectively associated with the plurality of subgraphs. In some implementations, determining the plurality of weight values respectively associated with the plurality of subgraphs can include using a cut-cost function to partition each subgraph from among the plurality of subgraphs into two subsets and determining the cost of partitioning each subgraph from among the plurality of subgraphs into one or more sets of two subsets. For example, the two subsets can include one or more nodes of the heterogeneous graph, and the cost of partitioning the subgraph into the two subsets can be the cut-cost of the subgraph. Each weight value can be the cut-cost of the subgraph or hyperedge. In some implementations, the cut-cost function can be a submodular cut-cost function and the cut-cost can be a submodular cut-cost. For example, a submodular cut-cost can be associated with a cut-cost function that discriminates cuts of the same subgraph or hyperedge. In other implementations, the cut-cost function can be a unit cut-cost function and the cut-cost can be a unit cut-cost, or the cut-cost function can be a cardinality-based cut-cost function and the cut-cost can be a cardinality cut-cost, where the cut-cost is based on the number of nodes in each subset.

At 706, the computing system selects at least one node from among the plurality of nodes.

At 708, the computing system learns, using an embedding objective computed based on the plurality of weight values, an embedding for the at least one node selected from among the plurality of nodes, wherein the embedding is based on a diffusion of an initial value distribution assigned to the at least one node selected from among the plurality of nodes. For example, a proxy objective can be iteratively computed. In some implementations, the embedding is a local node embedding comprising scores for the plurality of nodes in the heterogeneous graph. In some implementations, the embedding objective can be configured to encourage smooth score transition over adjacent nodes of the heterogeneous graph or hypergraph. In some examples, the scores can correspond to weight values of edges between local nodes and the plurality of nodes of the heterogeneous graph or hypergraph. The embeddings can be a vector of a length equal to a number of nodes that embeds nodes into a nonnegative real line.

At 710, the computing system processes the heterogeneous graph based on the embedding. In some implementations, processing the heterogeneous graph based on the embedding can include ranking the nodes. In another implementation, processing the heterogeneous graph based on the embedding can include constructing a similarity heterogeneous graph. In another implementation, processing the heterogeneous graph based on the embedding can include sorting local nodes and performing a sweep-cut method to obtain a smaller local cluster of nodes.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

In particular, although FIG. 7 depicts steps performed in a particular order for purposes of illustration and discussion, the methods of the present disclosure are not limited to the particularly illustrated order or arrangement. The various steps of method 700 can be omitted, rearranged, combined, and/or adapted in various ways without deviating from the scope of the present disclosure.

What is claimed is:

1. A method for obtaining local node embeddings for heterogeneous graphs, comprising:
obtaining, by a computing system comprising one or more processors, a heterogeneous graph comprising a plurality of nodes, wherein the heterogeneous graph comprises a plurality of subgraphs;
determining, by the computing system, a plurality of weight values respectively associated with the plurality of subgraphs;
selecting, by the computing system, at least one node from among the plurality of nodes;
learning, by the computing system and using an embedding objective computed based on the plurality of weight values, an embedding for the at least one node selected from among the plurality of nodes, wherein the embedding is based on a diffusion of an initial value distribution assigned to the at least one node selected from among the plurality of nodes; and
processing, by the computing system, the heterogeneous graph based on the embedding.

2. The method of claim 1, further comprising: creating, based on the heterogeneous graph, a hypergraph, wherein each subgraph from among the plurality of subgraphs comprises a hyperedge of the hypergraph.

3. The method of claim 2, wherein the hypergraph is a submodular hypergraph, wherein each hyperedge of the hypergraph is associated with a submodular function.

4. The method of claim 1, wherein the plurality of subgraphs describe higher-order semantic relationships across the plurality of nodes of the heterogeneous graph.

5. The method of claim 4, wherein the higher-order semantic relationships comprise determining a connection between a first node of the heterogeneous graph and a second node of the heterogeneous graph.

6. The method of claim 4, wherein the higher-order semantic relationships comprise determining a connection between a first node of the heterogeneous graph and two or more nodes of the heterogeneous graph.

7. The method of claim 4, wherein the higher-order semantic relationships comprise determining a connection between two or more nodes of the heterogeneous graph and another node of the heterogeneous graph.

8. The method of claim 1, wherein determining, by the computing system, a plurality of weight values respectively associated with the plurality of subgraphs comprises:
using a cut-cost function to partition each subgraph from among the plurality of subgraphs into two subsets, wherein the subsets include one or more nodes from among the plurality of nodes of the heterogeneous graph; and
determining a cost of partitioning each subgraph from among the plurality of subgraphs into two subsets, wherein the cost of partitioning a subgraph from among the plurality of subgraphs comprises a cut-cost of the subgraph.

9. The method of claim 8, wherein the cut-cost function comprises a submodular cut-cost function.

10. The method of claim 8, wherein each weight value from among the plurality of weight values comprises the cut-cost of the subgraph respectively associated with the weight value.

11. The method of claim 8 wherein the cut-cost comprises one or more of a submodular cut-cost, a unit cut-cost, and a cardinality-based cut-cost.

12. The method of claim 11, wherein the submodular cut-cost is associated with a cut-cost function that discriminates cuts of the same subgraph.

13. The method of claim 11, wherein the cardinality-based cut-cost comprises a cut-cost based on a number of nodes in each subset.

14. The method of claim 1, wherein using the embedding objective comprises iteratively computing a proxy objective.

15. The method of claim 1, wherein the embedding objective is configured to encourage smooth score transition over adjacent nodes from among the plurality of nodes.

16. The method of claim 1, wherein the scores for the plurality of nodes correspond to weight values of edges between one or more local nodes and the plurality of nodes.

17. The method of claim 1, wherein the embedding comprises a vector of a length equal to a number of nodes that embeds nodes into a nonnegative real line.

18. The method of claim 1, wherein processing, by the computing system, the heterogeneous graph based on the embedding comprises one or more of a ranking of the plurality of nodes, constructing a similarity heterogeneous graph, and sorting local nodes and performing a sweep-cut method to obtain a smaller local cluster of nodes.

19. A computing system for obtaining local node embeddings for heterogeneous graphs, the computing system comprising:
one or more processors;
one or more non-transitory computer-readable media that collectively store instructions that, when executed by the one or more processors, cause the one or more processors to perform operations, the operations comprising:
obtaining a heterogeneous graph comprising a plurality of nodes, wherein the heterogeneous graph comprises a plurality of subgraphs;
determining a plurality of weight values respectively associated with the plurality of subgraphs;
selecting at least one node from among the plurality of nodes;
learning, using an embedding objective computed based on the plurality of weight values, an embedding for the at least one node selected from among the plurality of nodes, wherein the embedding is based on a diffusion of an initial value distribution assigned to the at least one node selected from among the plurality of nodes; and
processing the heterogeneous graph based on the embedding.

20. One or more non-transitory computer-readable media that collectively store instructions that, when executed by one or more processors of a computing system, cause the computing system to perform operations, the operations comprising:
obtaining a heterogeneous graph comprising a plurality of nodes, wherein the heterogeneous graph comprises a plurality of subgraphs;
determining a plurality of weight values respectively associated with the plurality of subgraphs;
selecting at least one node from among the plurality of nodes;
learning, using an embedding objective computed based on the plurality of weight values, an embedding for the at least one node selected from among the plurality of nodes, wherein the embedding is based on a diffusion of an initial value distribution assigned to the at least one node selected from among the plurality of nodes; and
processing the heterogeneous graph based on the embedding.
